(19) United States
(12) Patent Application Publication
(10) Pub. No.: US 2013/0238993 A1
(43) Pub. Date: Sep. 12, 2013

(54) APPARATUS AND METHOD FOR ADDING CONTENT USING A MEDIA PLAYER

(71) Applicants: Eran Polack, Tel Aviv (IL); Amit Farbman, Tel Aviv (IL)

(72) Inventors: Eran Polack, Tel Aviv (IL); Amit Farbman, Tel Aviv (IL)

(73) Assignee: SCOOL T.V. LTD., Tel Aviv (IL)

(21) Appl. No.: 13/417,352

(22) Filed: Mar. 12, 2012

(51) Int. Cl. G06F 3/01

(52) U.S. Cl. 715/716

(57) ABSTRACT

It is an object of the subject matter to disclose a method performed on a media player, comprising: a. receiving a command from a user of the media player to add a content layer to a media file played on the media player; b. providing an interface to the user, said interface enables the user to add the content layer to the media file; transmitting the content layer to a server that stores the media file, such that the media file is configured to be displayed with the content layer.

### FIELD OF THE INVENTION

The subject matter relates generally to a media player and more specifically a method of adding content layers to a media file through a media player.

### BACKGROUND OF THE INVENTION

In the internet era, video is consumed in various ways. Many users view video files using open sharing websites such as YouTube, while other user view videos associated with known media corporates such as CNN. The video may be viewed on the website or using a media player at the user's device, such as a Personal Computer, Tablet, mobile phone and the like. Some of the media players enable users to access a media file stored on a remote server and view it. The user can watch the video, pause it, stop it, fast forward, rewind, skip ahead to a different media file or return to a previous media file.

### SUMMARY

It is an object of the subject matter to disclose a method performed on a media player, comprising: a. receiving a command from a user of the media player to add a content layer to a media file played on the media player; b. providing an interface to the user, said interface enables the user to add the content layer to the media file; transmitting the content layer to a server that stores the media file, such that the media file is configured to be displayed with the content layer.

In some cases, the method further comprises receiving data concerning a focal object in the media file, the focal object is defined by a creator of the media file; and determining a location of the content layer added to the media file, such that displaying the content layer does not overlap with the focal object on the media file.

In some cases, the method further comprises identifying the focal object on the media file before determining the location of the content layer on the media file.

In some cases, the content layer comprises content selected from a group consisting text, image, video, audio, and a combination thereof. In some cases, the media file is stored at a server accessible to a limited number of subscribers. In some cases, the media player enables a user to filter out excessive commentary.

In some cases, the method further comprises displaying content layers on the media file according to ranking of content layers provided to the media file. In some cases, the method further comprises pausing the media file when the content layer is displayed on the media file.

It is another object of the subject matter to disclose a media player, comprising: an input device for receiving a command from a user of the media player to add a content layer to a media file played on the media player; a content layer interface for enabling the user to add the content layer to the media file; a transmitter for transmitting the content layer to a server that stores the media file, such that the media file is configured to be displayed with the content layer.

In some cases, the media player further comprises an interface for receiving data concerning a focal object in the media file, the focal object is defined by a creator of the media file; focal object unit interface for determining a location of the content layer added to the media file, such that displaying the content layer does not overlap with the focal object on the media file.

In some cases, the media player further comprises an interface for identifying the focal object on the media file before determining the location of the content layer on the media file.

In some cases, the content layer comprises content selected from a group consisting text, image, video, audio, and a combination thereof.

In some cases, the media file is stored at a server accessible to a limited number of subscribers. In some cases, the media player further comprises a show content interface that enables a user to filter out excessive commentary.

In some cases, the show content interface is configured to display content layers on the media file according to ranking of content layers provided to the media file.

In some cases, the interface is configured to pause the media file when the content layer is displayed on the media file.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are optionally designated by the same numerals or letters.

FIG. 1 shows a media player with content layers, according to some exemplary embodiments of the subject matter.

FIG. 2A shows a media player with a text content layer adding interface, according to some exemplary embodiments of the subject matter;

FIG. 2B shows a media player with an image content layer adding interface, according to some exemplary embodiments of the subject matter;

FIG. 2C shows a media player with a video content layer adding interface, according to some exemplary embodiments of the subject matter;

FIG. 2D shows a media player with an audio content layer adding interface, according to some exemplary embodiments of the subject matter;

FIG. 3 shows a media player display section with an objection recognition unit, according to some exemplary embodiments of the subject matter; and,

FIG. 4 shows a media with content layers in different states of use, according to some exemplary embodiments of the subject matter.

### DETAILED DESCRIPTION

The present invention discloses a media player designed to enable a user to add content layers to a media file. The media player communicates with a display on which the user can view the media file. As the media file plays, the user may add a content layer to be viewed by future users of the media file. A content layer comprises additional content read in tandem with the media file. The content layer may also comprise data associated with the user who added the content layer to the media file, for example the user's name, user's picture and the like. The content layer does not become a part of the media file but is played with the media file to present additional content that appears on top of the media file. The time stamp and duration on which the content layer is displayed on the media file may be determined by the user who added the content layer, by a creator of the media file or automatically. In some cases, the media file is stored on a server accessible to a limited number of subscribers. In such a case, only the limited number of subscribers can view the media file.

A user adding a content layer to a media file may do so by pointing at a specific time stamp of the media file where the content layer is to be added, for example 1:13 minutes after the beginning of the media file. The user may then press on the control icon that enables the user to add the content layer. In some cases, the media player automatically pauses the media file from playing while the user adds the content layer. When the user finishes adding the content layer, the media player will transmit the content layer to the server that stores the media file and the content layer will be available for future users who play the media file. The media player comprises a transmitter for transmitting data related to content layer to a server storing the media file. The data transmitted by the transmitter may be the content layer, ranking of content layers, data of a user who generated the content layer and the like.

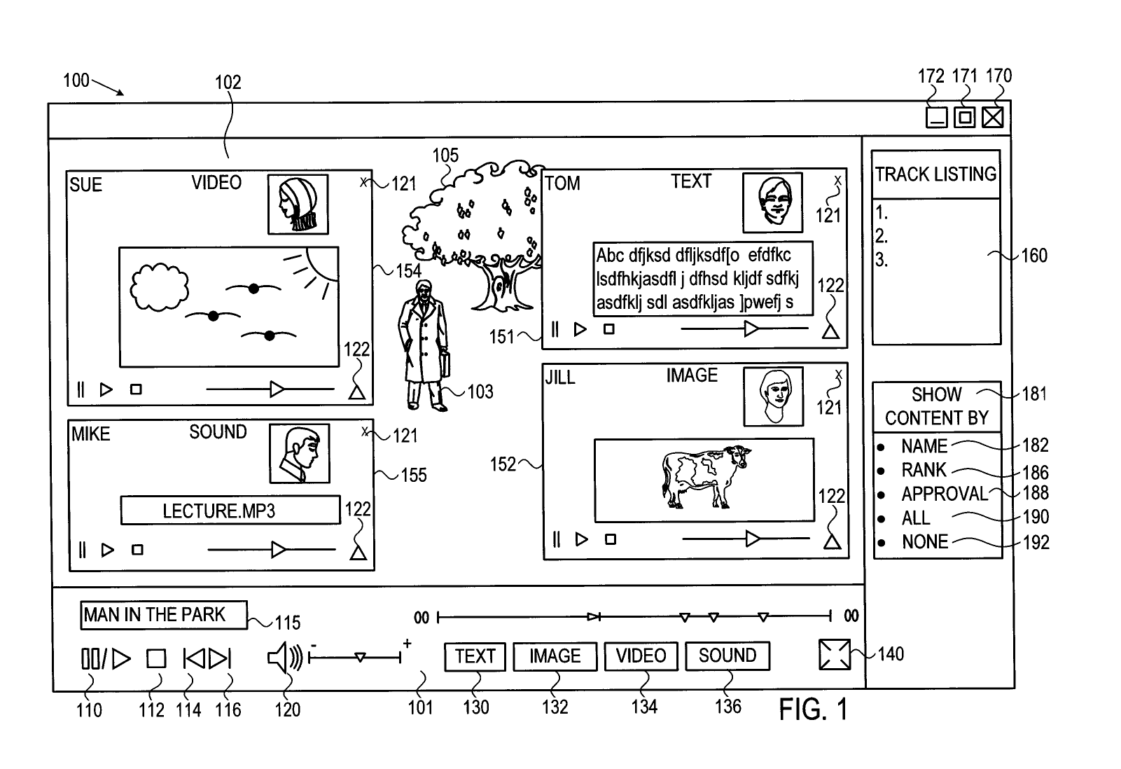

FIG. 1 shows a media player display 100, according to exemplary embodiments of the subject matter. The media player display includes a media display section 102 on which a media file is displayed on the media player. The media file may be a video file, an audio file or a combination thereof. A media file, for example a video as shown in FIG. 1, shows a person 103 and a tree 105. The media file displayed in the media display section 102 may also comprise user added content layers added to the media file. The content layers may be in the form of a text layer, a video layer, an image layer, an audio layer, and a combination thereof. The content layer is displayed in a content layer display section, such as video layer display section 154, text layer display section 151, image layer display section 152 and audio layer display section 155. The content layer display section may comprise control icons that enables the user to manipulate the display of the content layer, for example a close button 121 to close the content layer, and a minimize button 122 to minimize or maximize the content layer.

In some cases, the user of the media player will be able to chat with other users that view the same media file. The media player will indicate to the server storing the media file which users view the media file, for example using the transmission channel used to upload a content layer from the media player to the server. The media player may mark a user differently than a creator of the media file. The creator, or an instructor associated with the media file, for example a bartender associated with a video file that contains data on cocktails, can approach the user and suggest a private service or goods, for example a private lesson, either an online lesson or an offline lesson.

The media player interface 101 according to exemplary embodiment of the subject matter comprises content layer interface that enables the user to add a content layer to the media file. The user can add content layers of various types using an input device. The input device is used for receiving a command from a user of the media player to add a content layer to a media file played on the media player. For example, a text content layer may be inputted using a text button 130, image button 132, video button 134, or sound button 136. The media player interface 101 may comprise of a track listing display 160 that displays one or more media files available to the user.

In some cases, the media file displayed on the media display section 102 comprises content layers added by previous users of the media file. The user of the media player may be able to determine whether she desires to view the media file with or without at least some of the content layers added by the previous users. A show content interface 181 enables the user to choose which content layers are filtered out while the media file is played. The user can use the show content interface 181 to select parameters that will filter out at least a portion of the content layers added by users, for example excessive commentary. The show content interface 181 may comprise a title of the show content interface 181, for example stating “Show Content by:” 185. The user can choose to view content layers by various categories, for example, by a username 182 associated with a content layer, the ranking 186 of the username associated with a content layer, the rating 188 or ranking of the content layer, showing all content 190, or showing none of the content 192.

The media player display 100, according to exemplary embodiments of the subject matter, comprises a media player interface 101, which enables the user to control different settings of the media player. The media player interface 101 may include a time-ruler 125, which displays the progression of the media file, and a description display 115 that displays data related to the media file that is being displayed on the media display section 102. The user may view the media file on a full-screen display by pressing a full-screen icon 140. The media player interface 101 may comprise user interface buttons for controlling the media file progression and display. The interface may comprise, for example, a play and pause button 110 for playing or pausing the media file, a stop button 112 for stopping the display of the media file, a play previous button 114 to switch the display to show the previous media file, a play next button 116 to display the next media file available, and a volume control button 120 for manipulating the volume. The media player interface 101 may also include control icons such as a close button 170 to close the media player, a maximize button 171 for manipulating the size of the media player, and a minimize button 172 for minimizing the display of the media player.

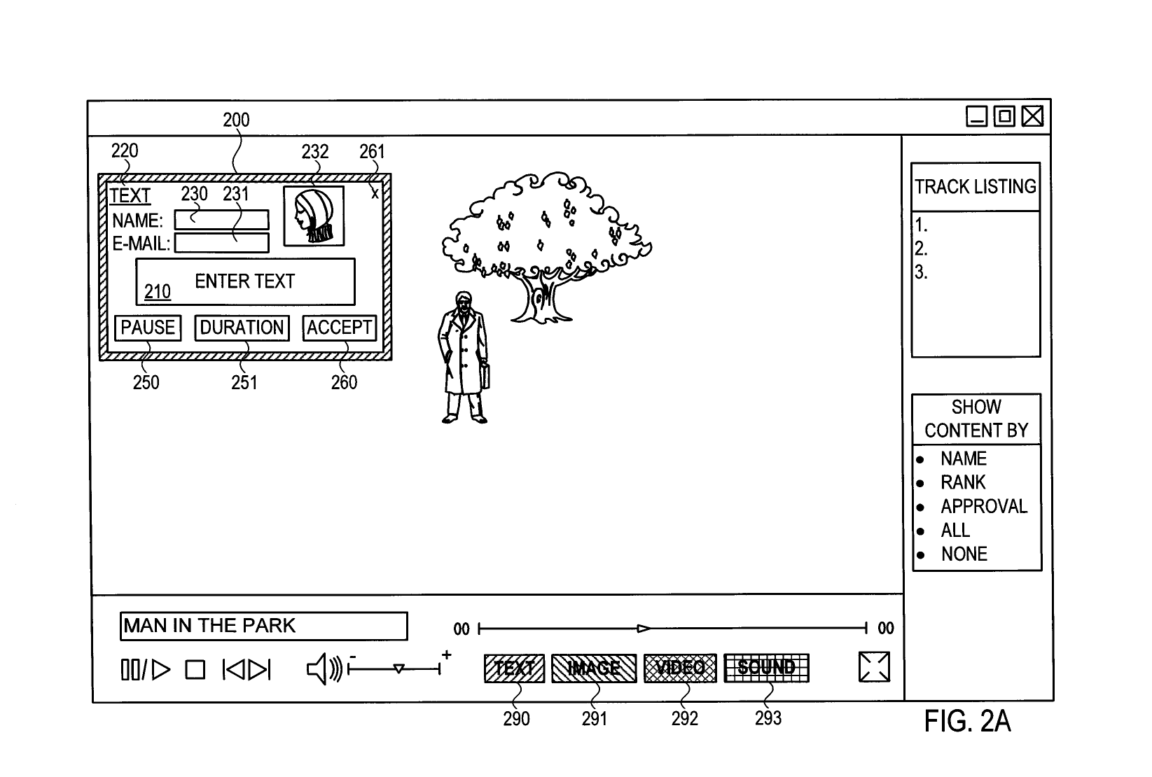

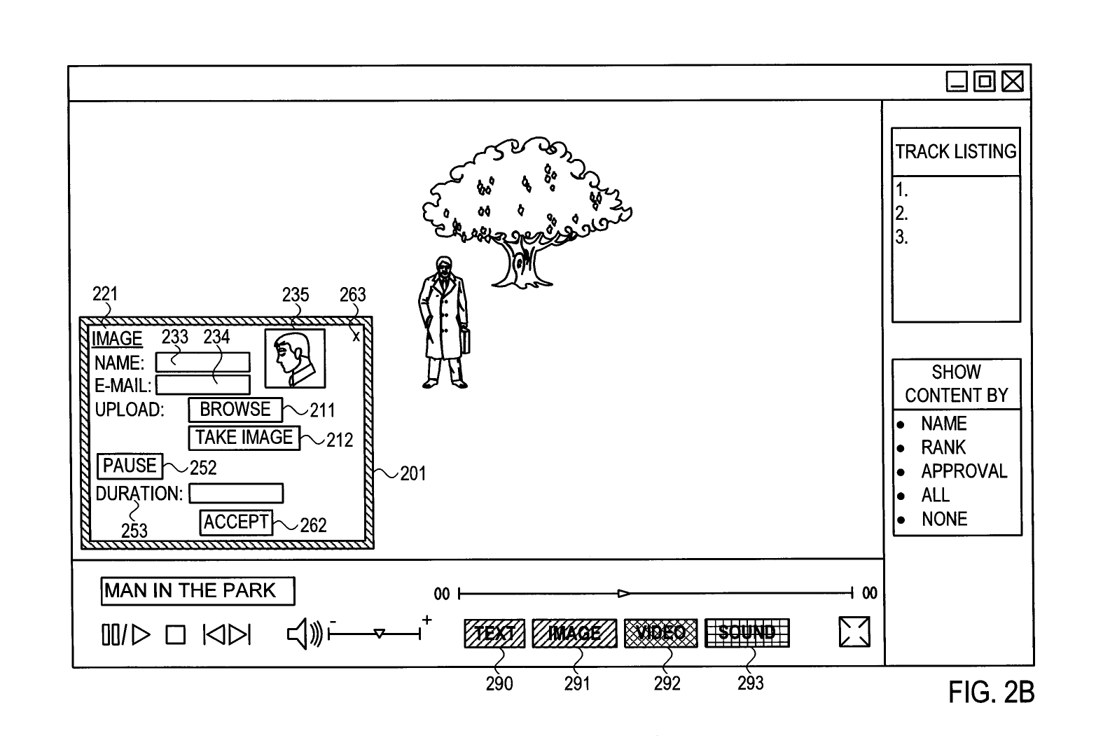

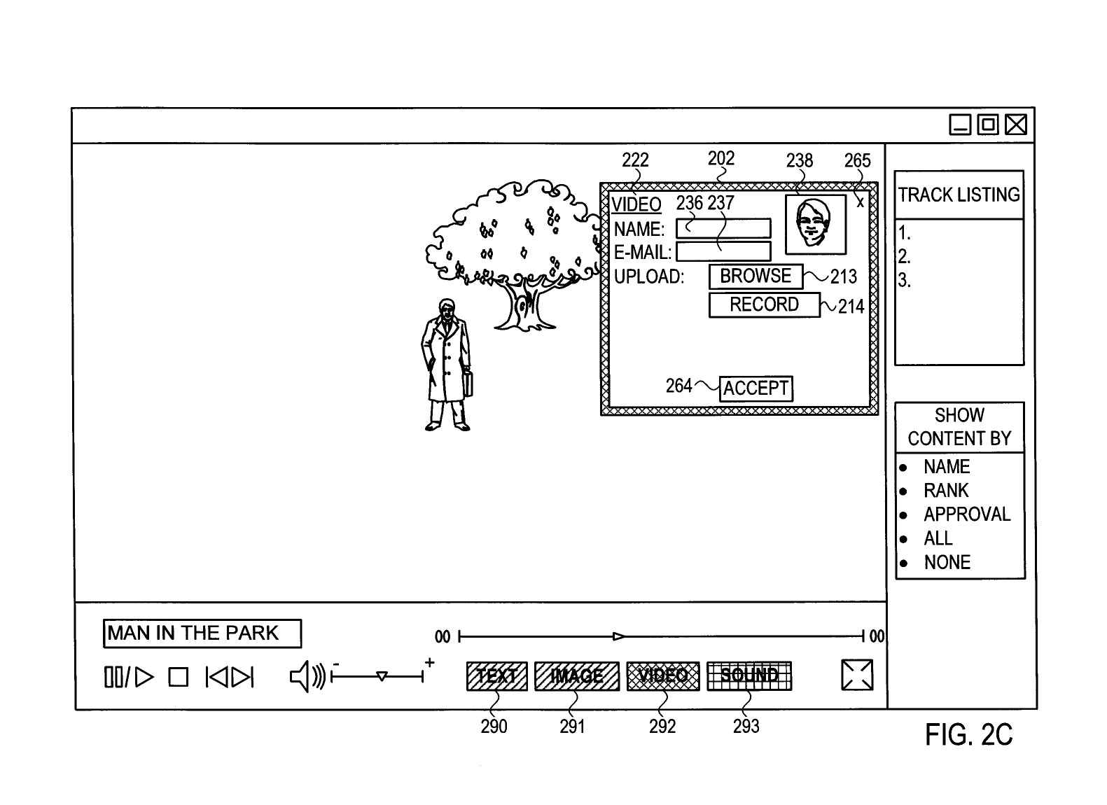

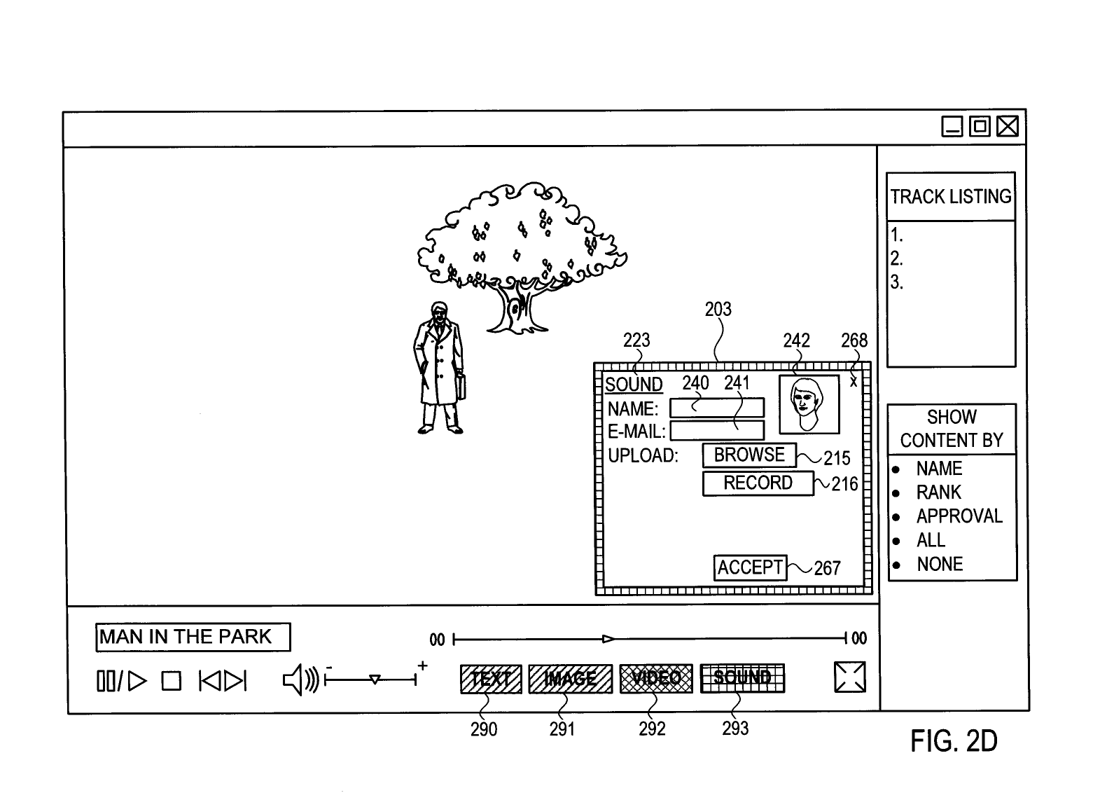

FIG. 2A shows a media player display section comprising a text content layer interface 200, according to exemplary embodiments of the disclosed subject matter. A text content layer interface 200 enables a user to add a text content layer to the media file. The text content layer interface 200 may be displayed on the media display section 102 after a user presses the text button 130 on the media player interface 101 (as shown in FIG. 1). The text content layer interface 200 comprises an interface, such as text box 210, for enabling the user to input text as a content layer. The user types a message into the text box 210, for example using a keyboard connected to a computerized device on which the media player is located. The text content layer interface 200 may comprise a title, such as “Text” 220 to inform the user that the type of content layer being uploaded is a text content layer. The text content layer interface 200 may comprise display sections used to input additional information related to the content layer, for example, an input for a username 230, a user's picture 232, and a user's e-mail 231. The text content layer interface 200 may comprise a pause icon 250. The pause icon 250 enables the user to pause the media file while the text content layer is being displayed on the media display section 102. The pause function may utilize a duration input 251 to enable a user to input the duration for pausing the media file. The text content layer interface 200 will enable a user to finalize the input of the content layer, for example by pressing an accept button 260. The text content layer interface 200 may also comprise a manner for cancelling the content layer creation, for example by having a close button 261.

FIG. 2B shows the media player display 100 with an image content layer interface 201 in the media display section 102, which will enable a user to add an image content layer. FIG. 2C shows the media player display 100 with a video content layer interface 202 in the media display section 102, which will enable a user to add a video content layer. FIG. 2D shows the media player display 100 with an audio content layer interface 203 in the media display section 102, which will enable a user to add an audio content layer.

The content layer creation interfaces may appear on the media display section 102 after the user presses the image button 132 for the image content layer interface 201, the video button 134 for the video content layer interface 202, and the sound button 133 for the audio content layer interface 203. The content layer creation interface will enable the user to input content into the content layer, for example inputting an image by using a browse command, or taking a picture with a camera. Similar to the text content layer interface 200, the image content layer interface 201, the video content layer interface 202, and the audio content layer interface 203 may comprise a title, an input field for inputting a username, a user picture, and a user e-mail. The may comprise a pause icon 252. The image content layer interface 201, the video content layer interface 202, and the audio content layer interface 203 will enable a user to finalize the input of the content layer, for example by pressing an “Accept” button 260. The image content layer interface 201, the video content layer interface 202, and the audio content layer interface 203 may also comprise a manner for cancelling the content layer creation, for example by having a close button 261.

Addition of certain content layers may pause the media file during the display of the content layer, for example when the content layer contains video or audio. Other content layers may not require the media file to pause, however the user creating the content layer chooses to have the media file pause so future users can concentrate solely on the content layer while it is being displayed, for example a text context layer with long text. When a content layer defined by the user who adds the content layer is enabled to pause a media file being displayed, the media player receives a pause command associated with the content layer and a time stamp and pauses the media file accordingly. The media file remains paused until the content layer is terminates. When the content layer terminates, the media player resumes the media file from where the media file was paused. In some exemplary embodiments of the subject matter, the content layer will be removed from the display of the media player in an automatic manner or by the user.

In some cases, the creator of the media file may define a focal object in the media file. The focal object is an object in the media file configured to be displayed by users that can add content layers to the media file. The focal object is defined by the creator of the media file as an object that shall not be blocked by any content layer later added by users. In an exemplary embodiment of the subject matter, when a content layer is inputted by the user, the content layer, along with the media file and the focal object are sent to a focal object unit. The focal object unit provides that the content layer does not block the focal object throughout the display of the media file on the media player.

In another exemplary embodiment of the subject matter, the focal object unit works in real-time while the media file is being displayed on the media player. When a content layer is displayed, the user can move the content layer on the media display section 102 by using an input device, for example a mouse. If the user attempts to move the content layer onto the focal object, the focal object unit will move the content layer to a different location of the media display section 102.

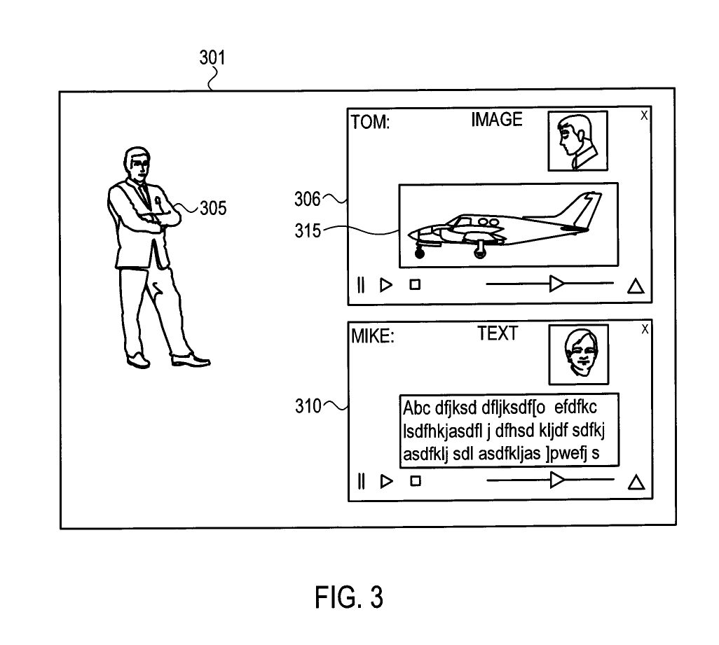

FIG. 3 shows a media player display 301 with the focal object unit, according to exemplary embodiments of the disclosed subject matter. The media player display 301 is playing a media file consisting of video. A person 305 displayed in the media file, for example a tutor, is defined as the focal object. In some exemplary cases, the media player is receiving data of the focal object before playing the media file or before displaying content layers added by users to the media file. The media file displayed on the media player display 301 comprises a text content layer 310 and an image content layer 315 added by users who previously viewed the media file. The text content layer 310 and an image content layer 315 are not overlapping the person 305 according to definitions provided by the focal object unit. For example, the focal object unit may determine a location in which a content layer cannot be displayed after preprocessing the media file and storing the location of the person 305 in one or more time sections along the media file. In contrast, the blackboard 306 is not defined in the media file as a focal object and thus is blocked by the image content layer 315.

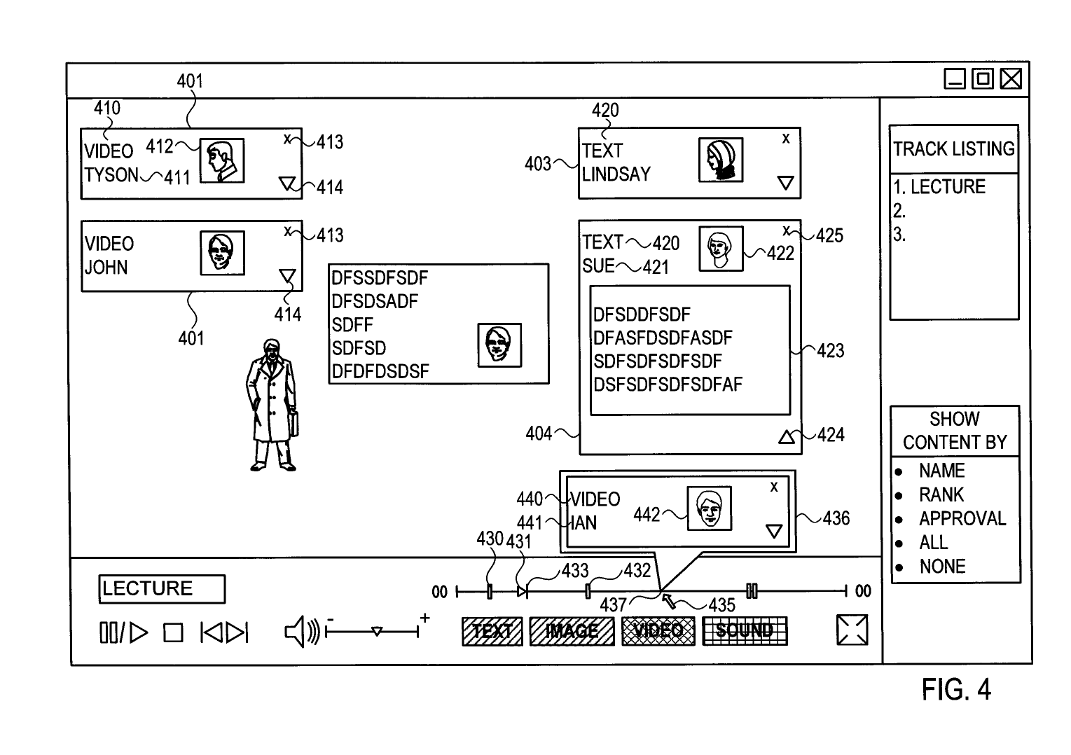

After a content layer is uploaded by the user, the content layer can be viewed by other users. When the content layer is inputted by the user, the media player creates a time marker. The time marker enables a media player to associate a content layer with a time stamp at which the content layer is defined to be displayed, for example 2 minutes and 42 seconds after the beginning of the media file. As shown in FIG. 4, the time marker 437 may also be displayed on the time-ruler 125. The media player may display when a certain content layer will be displayed on the media display section 102. The time marker 437 may enable a user to see a content layer information display 436, which may include the type of content layer 440, the username 441, and picture 442 of the user that uploaded the video. Reviewing the content layer information display 436 can be done for example by scrolling a mouse controlled arrow 435 over the time marker 437.

An uploaded content layer will appear on the media display section when the media player displaying the media file reaches the time marker of the media file where the user uploaded the content layer. When the media player reaches the time marker, the content layer is displayed on the media display section 102. The content layer 423 may be displayed as a portion of a content layer package. The content layer package may be displayed on the media display section 102 in two formats, a first format comprises of a content layer information display 403 displaying only metadata of the content layer and a second format comprises an entire content layer display displaying the content layer 423 as well as the metadata. The metadata of the content layer 423 comprises the type of content in the content layer, for example the title 410, the username and user picture of the user that uploaded the content layer 423.

In some cases, the media file displays only the metadata, as shown in content layer information display 401, 402. The content layer information displays 401, 402 are arranged in the same area on the media display section 102, in which the user can expand the display using an expend button 414 or minimize the display using a minimize button 413. In the second format, the metadata may include the type of content layer such as the username 411, and the user picture 412 of the user that uploaded the content layer.

The subject matter also discloses a content layer server for storing media files such as video files. The content layer server enables users to view the media files, for example using a media player of the disclosed subject matter. The content layer server receives information from the users of the media file, for example information concerning addition of content layers to the media file. The content layer server then determines whether or not to add the content layer to the media file. In some cases, the content layer server adds the content layer provided from the users to the media file. In some cases, when another user wishes to view the media file, the content layer server displays the media file with the content layer added by the previous user.

While a preferred embodiment of the invention has been illustrated and described, it is to be understood that various changes can be made therein without departing from the spirit of the invention as defined by the appended claims.

What is claimed is:

1. A method performed on a media player, comprising:
a. receiving a command from a user of the media player to add a content layer to a media file played on the media player;
b. providing an interface to the user, said interface enables the user to add the content layer to the media file;
c. transmitting the content layer to a server that stores the media file, such that the media file is configured to be displayed with the content layer.

2. The method of claim 1, further comprises:
receiving data concerning a focal object in the media file, the focal object is defined by a creator of the media file;
determining a location of the content layer added to the media file, such that displaying the content layer does not overlap with the focal object on the media file.

3. The method of claim 2, further comprises identifying the focal object on the media file before determining the location of the content layer on the media file.

4. The method of claim 1, wherein the content layer comprises content selected from a group consisting text, image, video, audio, and a combination thereof.

5. The method of claim 1, wherein the media file is stored at a server accessible to a limited number of subscribers.

6. The method of claim 1 wherein the media player enables a user to filter out excessive commentary.

7. The method of claim 1, further comprises displaying content layers on the media file according to ranking of content layers provided to the media file.

8. The method of claim 1, further comprises pausing the media file when the content layer is displayed on the media file.

9. A media player, comprising:
a. an input device for receiving a command from a user of the media player to add a content layer to a media file played on the media player;
b. a content layer interface for enabling the user to add the content layer to the media file;
c. a transmitter for transmitting the content layer to a server that stores the media file, such that the media file is configured to be displayed with the content layer.

10. The media player of claim 9, further comprising:
an interface for receiving data concerning a focal object in the media file, the focal object is defined by a creator of the media file;
a focal object unit for determining a location of the content layer added to the media file, such that displaying the content layer does not overlap with the focal object on the media file.

11. The media player of claim 9, further comprises an interface for identifying the focal object on the media file before determining the location of the content layer on the media file.

12. The media player of claim 9, wherein the content layer comprises content selected from a group consisting text, image, video, audio, and a combination thereof.

13. The media player of claim 9, wherein the media file is stored at a server accessible to a limited number of subscribers.

14. The media player of claim 9, further comprises a show content interface that enables a user to filter out excessive commentary.

15. The media player of claim 9, wherein the show content interface is configured to display content layers on the media file according to ranking of content layers provided to the media file.

16. The media player of claim 9, wherein the interface is configured to pause the media file when the content layer is displayed on the media file.
